(19) United States
(12) Patent Application Publication
(10) Pub. No.: US 2015/0259580 A1
(43) Pub. Date: Sep. 17, 2015

(54) FIBER REINFORCED HIGH MODULUS POLYMER COMPOSITE WITH A REINFORCED INTERPHASE

(71) Applicant: TORAY INDUSTRIES, INC., Chuo-ku, Tokyo (JP)

(72) Inventors: Felix N. Nguyen, Tacoma, WA (US); Alfred P. Haro, Tacoma, WA (US); Kenichi Yoshioka, Tacoma, WA (US)

(73) Assignee: Toray Industries, Inc., Tokyo (JP)

(21) Appl. No.: 14/435,494

(22) PCT Filed: Oct. 10, 2013
(86) PCT No.: PCT/IB2013/002263

§ 371 Date: Apr. 14, 2015

Related U.S. Application Data
(60) Provisional application No. 61/873,647, filed on Sep. 4, 2013.
(60) Provisional application No. 61/713,928, filed on Oct. 15, 2012.

(51) Int. Cl. C09J 163/00; C09J 163/04; C09J 9/00; C09J 11/04; C09J 11/08

(52) U.S. Cl. CPC C09J 163/00; C09J 11/04; C09J 11/08; C09J 9/00; C09J 163/04

(57) ABSTRACT

A fiber reinforced polymer composition is disclosed comprising a reinforcing fiber and an adhesive composition, wherein the adhesive composition comprises at least a thermosetting resin, a curing agent, and an interfacial material, the fiber is suitable for concentrating the interfacial material in an interfacial region between the fiber and the adhesive composition upon curing of the adhesive composition, and the cured adhesive has a resin modulus of at least 4.0 GPa. Also provided is a prepreg comprising the fiber reinforced polymer composition and a method of manufacturing a composite article by curing the reinforced polymer composition. The resulting interfacial region, viz., the reinforced interphase, is reinforced by one or more layers of the interfacial material such that substantial improvements in tensile, compression and fracture toughness may be observed.

### INCORPORATION BY REFERENCE

The disclosures of U.S. provisional application No. 61/713,928, filed Oct. 15, 2012, U.S. provisional application No. 61/713,939, filed Oct. 15, 2012, U.S. provisional application No. 61/873,647, filed Sep. 4, 2013, and U.S. provisional application No. 61/873,659, filed Sep. 4, 2013, are each incorporated herein by reference in their entireties for all purposes.

### FIELD OF THE INVENTION

The present application provides an innovative fiber reinforced polymer composition comprising a reinforcing fiber and a high modulus adhesive composition in that upon curing of the adhesive composition, a distinct interfacial region between the reinforcing fiber and the cured adhesive composition is formed (hereafter referred to as a “reinforced interphase”), allowing simultaneous improvement of tensile, fracture toughness and compressive properties.

### BACKGROUND OF THE INVENTION

To increase fracture toughness of a fiber reinforced polymer composite, specifically mode I interlaminar fracture toughness G_{IC}, a conventional approach is to toughen the polymer resin matrix with a submicrometer-sized or smaller soft polymeric toughening agent. Upon curing of the composite the toughening agent is most likely spatially found inside the fiber bed/matrix region, called the intraply as opposed to the resin-rich region between two plies, called the interply. Uniform distribution of the toughening agent is often expected to maximize G_{IC}. Examples of such resin compositions include: U.S. Pat. No. 6,063,839 (Oosedo et al., Toray Industries, Inc., 2000), EP2256163A1 (Kamae et al., Toray Industries, Inc., 2009) with rubbery soft core/hard shell particles; U.S. Pat. No. 6,878,776B1 (Pascault et al., Cray Valley S.A., 2005) for reactive polymeric particles; U.S. Pat. No. 6,894,113B2 (Court et al., Atofina, 2005) for block copolymers; and US20100280151A1 (Nguyen et al., Toray Industries Inc., 2010) for reactive hard core/soft shell particles. For these cases, since a soft material was incorporated in the resin in a large amount either by weight or volume, G_{IC} increased substantially, and the soft material potentially effectively dissipated the crack energy from the fiber's broken ends. Nevertheless, since the resin modulus was substantially reduced, or at most maintained as in the case of US20100280151A1, a substantial reduction in stress transferring capability of the matrix to the fibers can be rationalized. Therefore, tensile and tensile-related properties could be reduced to a significant extent. In addition, a substantial reduction in the resin modulus leads to a large penalty of resin modulus dependence properties of the composite (e.g., compression, flexure, interlaminar shear). On the other hand, if a high resin modulus can be achieved, typically the resin becomes brittle, and therefore although compressive properties increase, tensile and fracture toughness decrease. Moreover, if a strong adhesion between the fiber and the resin could be achieved, interfacial resin embrittlement could result. Cracks could initiate and cause both early tensile and fracture toughness failures. In short, there exists a trade-off among adhesion dependent properties (e.g., tension, and shear), compressive, and fracture toughness properties of the fiber reinforced polymer composite in that improvement of one property leads to a deterioration of one or both other properties. Subsequently, a resin with high adhesion to the reinforcement, high modulus and high toughness is desirably sought.

To resolve the aforementioned challenges, WO2012116261A1 (Nguyen et al., Toray Industries Inc., 2012) utilizes a reinforced interphase concept by concentrating an interfacial material at the interphase between an adhesive resin composition and a reinforcing fiber. High adhesion of the adhesive resin composition to the fiber was achieved. In addition, by engineering the interphase with a soft nanomaterial toughener, high toughness of the resin composition was also obtained. As a result, both tensile strength and fracture toughness of the fiber composite simultaneously increased but at the expense of compressive properties. U.S. Pat. No. 6,515,081B2 (Oosedo et al., Toray Industries Inc., 2003) and U.S. Pat. No. 6,399,199B1 (Fujino et al., Toray Industries Inc., 2002) attempted to increase compressive strength, flexural strength and interlaminar shear strength by incorporating an adhesion promoter containing an amide group in a resin composition that can also increase the resin modulus without penalizing too much its toughness. However, with a limited resin modulus and without a reinforced interphase they could only achieve marginal improvements and failed to maximize these strengths. U.S. Pat. No. 5,599,629 (Gardner et al., Amoco Corporation, 1997) introduced a high modulus and strength epoxy resin comprising an aromatic amidoamine hardener having a single benzene ring. However, adhesion of the resin to fibers was not discussed.

### SUMMARY OF THE INVENTION

An embodiment relates to a fiber reinforced polymer composition comprising a reinforcing fiber and an adhesive composition, wherein the adhesive composition comprises at least a thermosetting resin, a curing agent and an interfacial material, the adhesive composition when cured has a resin modulus of at least about 4.0 GPa and forms good bonds to the reinforcing fiber, the reinforcing fiber is suitable for concentrating the interfacial material in an interfacial region between the reinforcing fiber and the adhesive composition, and the interfacial region comprises at least the interfacial material. The adhesive composition may further comprise one or more of a migrating agent, an accelerator, a toughener/filler, and an interlayer toughener. The cure adhesive composition could have a resin modulus of at least 4 GPa and a flexural deflection of at least 3 mm. The curing agent could comprise at least an amide group and at least an aromatic group. The curing agent could further comprise a curable functional group.

Another embodiment of the invention relates to a fiber reinforced polymer composition comprising a carbon fiber and an adhesive composition, wherein the adhesive composition is comprised of an epoxy resin, an interfacial material comprising a core-shell particle, an amidoamine curing agent and a migrating agent selected from the group consisting of polyethersulfones, polyetherimides, and mixtures thereof, and wherein the interfacial material has a gradient in concentration in an interfacial region between the cured adhesive composition and the reinforcing fiber. The amidoamine curing agent might comprise at least an amide group and at least one aromatic group. The curing agent could comprise at least one member selected from aminobenzamides, diaminobenzanilides, aminoterephthalamides and aminobenzenesulfonamides. The adhesive composition may further comprise one or more of an accelerator, a toughener/filler, and an interlayer toughener.

Another embodiment of the invention relates to a fiber reinforced polymer composition comprising a reinforcing fiber and an adhesive composition, wherein the adhesive composition comprises at least a thermosetting resin, a curing agent and an interfacial material, wherein the interfacial material has a gradient in concentration in an interfacial region between the cured thermosetting resin and the reinforcing fiber, and the cured fiber reinforced polymer simultaneously achieves a tensile strength of at least 80% translation, a compression strength of at least 1380 MPa (200 ksi), and mode I fracture toughness of at least 350 J/m² (2 lb·in/in²).

Other embodiments relate to a prepreg comprising one of the above fiber reinforced polymer compositions.

Other embodiments relate to a method of manufacturing a composite article comprising curing one of the above fiber reinforced polymer compositions.

### BRIEF DESCRIPTIONS OF THE DRAWINGS

FIG. 1 shows a schematic 90° cross-section view of a cured fiber reinforced polymer composite structure. The interfacial material, which may be insoluble or partially soluble, is concentrated in the vicinity of the fibers. An interfacial region or interphase is approximately present from the fiber's surface to the dashed line, where the concentration of the interfacial material is no longer substantially higher than the bulk adhesive resin composition. One layer of the interfacial material is also illustrated.

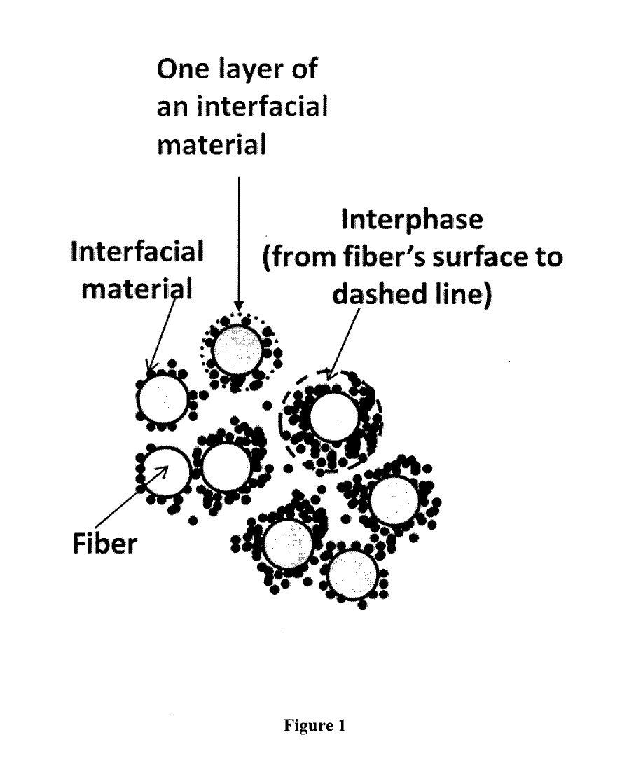

FIG. 2 shows a schematic 0° cross-section view of the cured composite structure. The interfacial material, which may be insoluble or partially soluble, is concentrated on the fiber's surface with the (cured) adhesive. The figure illustrates a case of good particle migration.

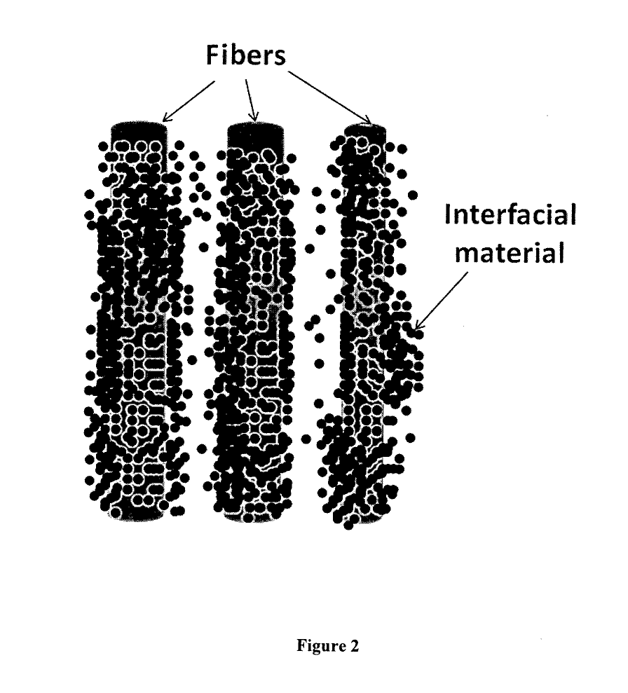

### DETAILED DESCRIPTION OF THE INVENTION

An embodiment of the invention relates to a fiber reinforced polymer composition comprising a reinforcing fiber and an adhesive composition, wherein the adhesive composition comprises at least a thermosetting resin, a curing agent and an interfacial material, the adhesive composition when cured has a resin modulus of at least about 4.0 GPa and forms good bonds to the reinforcing fiber, the reinforcing fiber is suitable for concentrating the interfacial material in an interfacial region between the reinforcing fiber and the adhesive composition (herein referred to as ‘an interphase’), and the interfacial region comprises at least the interfacial material.

In this embodiment, any reinforcing fiber suitable for concentrating the interfacial material in an interfacial region between the reinforcing fiber could be used. Such reinforcing fiber, in various embodiments of the invention, has a non-polar surface energy at 30° C. of at least 30 mJ/m², at least 40 mJ/m², or even at least 50 mJ/m² and/or a polar surface energy at 30° C. of at least 2 mJ/m², at least 5 mJ/m², or even at least 10 mJ/m². High surface energies are needed to promote wetting of the adhesive composition on the reinforcing fiber and to promote concentration of the interfacial material in the vicinity of the reinforcing fiber. This condition is also necessary to promote good bonds.

Non-polar and polar surface energies could be measured by an inverse gas chromatography (IGC) method using vapors of probe liquids and their saturated vapor pressures. IGC can be performed according to Sun and Berg's publications (Advances in Colloid and Interface Science 105 (2003) 151-175 and Journal of Chromatography A, 969 (2002) 59-72). A brief summary is described in the paragraph below.

Vapors of known liquid probes are carried into a tube packed with solid materials of unknown surface energy and interacted with the surface. Based on the time that a gas traverses through the tube and the retention volume of the gas, the free energy of adsorption can be determined. Hence, the non-polar surface energy can be determined from a series of alkane probes, whereas the polar surface energy can be roughly estimated using two acid/base probes.

There are no specific limitations or restrictions on the choice of a reinforcing fiber, as long as it is suitable for concentrating the interfacial material in an interfacial region between the reinforcing fiber and the adhesive composition. Examples include carbon fibers, organic fibers such as aramid fibers, silicon carbide fibers, metal fibers (e.g., alumina fibers), boron fibers, tungsten carbide fibers, glass fibers, and natural/bio fibers. Carbon fiber in particular is used to provide the cured fiber reinforced polymer composition exceptionally high strength and stiffness as well as light weight. Of all carbon fibers, those with a strength of 2000 MPa or higher, an elongation of 0.5% or higher, and modulus of 200 GPa or higher are preferably used.

The form and the arrangement of a plurality of the reinforcing fibers used are not specifically defined. Any of the forms and spatial arrangements of the reinforcing fibers known in the art such as long fibers in a direction, chopped fibers in random orientation, single tow, narrow tow, woven fabrics, mats, knitted fabrics, and braids can be employed. The term “long fiber” as used herein refers to a single fiber that is substantially continuous over 10 mm or longer or a fiber bundle comprising the single fibers. The term “short fibers” as used herein refers to a fiber bundle comprising fibers that are cut into lengths of shorter than 10 mm. Particularly in the use applications for which high specific strength and high specific elastic modulus are required, a form wherein a reinforcing fiber bundle is arranged in one direction may be most suitable. From the viewpoint of ease of handling, a cloth-like (woven fabric) form is also suitable for the present invention.

In cases when the reinforcing fiber is a carbon fiber, instead of using surface energies described above for a selection of suitable carbon fibers for concentrating the interfacial material, an interfacial shear strength (IFSS) value of at least 20 MPa, at least 25 MPa, or even at least 30 MPa, determined in a single fiber fragmentation test (SFFT) according to Rich et al. in “Round Robin Assessment of the Single Fiber Fragmentation Test” in Proceeding of the American Society for Composites: 17th Technical conference (2002), paper 158 could be needed. A brief description of SFFT is described in a paragraph below.

A single fiber composite coupon having a single carbon fiber embedded in the center of a dog-boned cured resin is strained without breaking the coupon until the set fiber length no longer produces fragments. IFSS is determined from the fiber strength, the fiber diameter, and the critical fragment length determined by the set fiber length divided by the number of fragments.

In order to achieve such high IFSS, the carbon fiber typically is oxidized or surface treated by an available method in the art (e.g., plasma treatment, UV treatment, plasma assisted microwave treatment, and/or wet chemical-electrical oxidization) to increase its concentration of oxygen to carbon (O/C). The O/C concentration can be measured by an X-ray photoelectron spectroscopy (XPS). A desired O/C concentration may be at least 0.05, at least 0.1, or even at least 0.15. The oxidized carbon fiber is coated with a sizing material such as an organic material or organic/inorganic material such as a silane coupling agent or a silane network or a polymer composition compatible and/or chemically reactive with the adhesive composition to improve bonding strengths. For example, if the adhesive resin composition comprises an epoxy, the sizing material could have functional groups such as epoxy groups, amine groups, amide groups, carboxylic groups, carbonyl groups, hydroxyl groups, and other suitable oxygen-containing or nitrogen-containing groups. Both the O/C concentration on the surface of the carbon fiber and the sizing material collectively are selected to promote adhesion of the adhesive composition to the carbon fiber. There is no restriction on the possible choices of the sizing material as long as the requirement of surface energies of the carbon fiber for an interphase formation is met and/or the sizing promotes good bonds.

Good adhesion between the adhesive composition and the reinforcing fiber herein refers to “good bonds” in that one or more components of the adhesive composition chemically react with functional groups found on the reinforcing fiber's surface to form cross-links. Good bonds can be documented by examining the cured fiber reinforced polymer composition after being fractured under a scanning electron microscope (SEM) for failure modes. Adhesive failure refers to a fracture failure at the interface between the reinforcing fiber and the cured adhesive composition, exposing the fiber's surface with little or no adhesive found on the surface. Cohesive failure refers to a fracture failure which occurs in the cured adhesive composition, wherein the fiber's surface is mainly covered with the adhesive composition. Note that cohesive failure in the fiber may occur, but it is not referred to in the invention herein. The coverage of the fiber surface with the cured adhesive composition could be about 50% or more, or about 70% or more. Mixed mode failure refers to a combination of adhesive failure and cohesive failure. Adhesive failure refers to weak adhesion and cohesive failure is strong adhesion, while mixed mode failure results in adhesion somewhere in between weak adhesion and strong adhesion and typically has a coverage of the fiber surface by the cured adhesive composition of about 20% or more. Mixed mode and cohesive failures herein are referred to as a good bond between the cured adhesive composition and the fiber surface while adhesive failure constitutes a poor bond. To have good bonds between carbon fibers and the cured adhesive composition an IFSS value of at least 20 MPa could be needed. Alternatively, a measurement of fiber-matrix adhesion could be obtained by interlaminar shear strength (ILSS) described by ASTM D-2344 of the cured fiber reinforced polymer composition. Good bonds could refer to an IFSS of at least 25 MPa, at least 30 MPa or even 35 MPa and/or a value of ILSS of at least 14 ksi, at least 15 ksi, at least 16 ksi, or even at least 17 ksi. Ideally, both an observation of failure modes and an IFSS value are needed to confirm good bonds. However, generally, when either observations of failure modes or an IFSS value cannot be obtained, an ILSS value between 13-14 ksi could indicate a mixed mode failure while an ILSS value above 16 ksi could indicate a cohesive failure and an ILSS value between 14-15 ksi could indicate either mixed mode or cohesive failure, depending on the reinforcing fiber and the adhesive composition.

The adhesive composition when cured has a flexural resin modulus (hereafter called “resin modulus” at room temperature dry measured in accordance with a three point bend method described in ASTM D-790) of at least 4.0 GPa, at least 4.5 GPa, or even at least 5.0 GPa. When a resin modulus is at least 4.0 GPa, it provides the cured fiber reinforced polymer composition excellent compression strength, open-hole compression strength and 0° flexural strength in that a higher resin modulus tends to provide the higher strengths and in some cases tension strength and/or 90° flexural strength might be sacrificed to some extent. Yet, when the cured adhesive composition has a flexural deflection of at least 3 mm, the cured fiber reinforced polymer composition can maintain or improve those strengths. Nevertheless, a combination of good bonds and the interphase comprising at least the interfacial material (herein is referred to ‘a reinforced interphase’) could further improve those strengths. Synergistic effects of a combination of (1) the reinforced interphase, (2) good bonds and (3) the resin modulus of at least 4.0 GPa provide an excellent performance envelope comprising at least tensile strength, compressive strength, fracture toughness and interlaminar shear strength of the cured fiber reinforced polymer composition. This might not be achieved by individual elements or the combination of two elements alone.

The thermosetting resin in the adhesive composition may be defined herein as any resin which can be cured with a curing agent or a cross-linker compound by means of an externally supplied source of energy (e.g., heat, light, electromagnetic waves such as microwaves, UV, electron beam, or other suitable methods) to form a three dimensional crosslinked network having the required resin modulus. The thermosetting resin may be selected from, but is not limited to, epoxy resins, epoxy novolac resins, ester resins, vinyl ester resins, cyanate ester resins, maleimide resins, bismaleimide-triazine resins, phenolic resins, novolac resins, resorcinolic resins, unsaturated polyester resins, diallylphthalate resins, urea resins, melamine resins, benzoxazine resins, polyurethanes, and mixtures thereof and mixtures thereof, as long as it contributes to the formation of the interphase and the resin modulus and the good bonds satisfy the above conditions.

From the view point of an exceptional balance of strength, strain, modulus and environmental effect resistance, of the above thermosetting resins, epoxy resins could be used, including mono-, di-functional, and higher functional (or multifunctional) epoxy resins and mixtures thereof. Multifunctional epoxy resins are preferably selected as they provide excellent glass transition temperature (Tg), modulus and even high adhesion to a reinforcing fiber. These epoxies are prepared from precursors such as amines (e.g., epoxy resins prepared using diamines and compounds containing at least one amine group and at least one hydroxyl group such as tetraglycidyl diaminodiphenyl methane, triglycidyl-p-aminophenol, triglycidyl-m-aminophenol, triglycidyl aminocresol and tetraglycidyl xylylenediamine and their isomers), phenols (e.g., bisphenol A epoxy resins, bisphenol F epoxy resins, bisphenol S epoxy resins, bisphenol R epoxy resins, phenol-novolac epoxy resins, cresol-novolac epoxy resins and resorcinol epoxy resins), naphthalene epoxy resins, dicyclopentadiene epoxy resins, epoxy resins having a biphenyl skeleton, isocyanate-modified epoxy resins and compounds having a carbon-carbon double bond (e.g., alicyclic epoxy resins). It should be noted that the epoxy resins are not restricted to the examples above. Halogenated epoxy resins prepared by halogenating these epoxy resins can also be used. Furthermore, mixtures of two or more of these epoxy resins, and compounds having one epoxy group or monoepoxy compounds such as glycidylaniline, glycidyl toluidine or other glycidylamines (particularly glycidylaromatic amines) can be employed in the formulation of the thermosetting resin matrix.

Examples of commercially available products of bisphenol A epoxy resins include “jER (registered trademark)” 825, “jER (registered trademark)” 828, “jER (registered trademark)” 834, “jER (registered trademark)” 1001, “jER (registered trademark)” 1002, “jER (registered trademark)” 1003, “jER (registered trademark)” 1003F, “jER (registered trademark)” 1004, “jER (registered trademark)” 1004AF, “jER (registered trademark)” 1005F, “jER (registered trademark)” 1006FS, “jER (registered trademark)” 1007, “jER (registered trademark)” 1009 and “jER (registered trademark)” 1010 (which are manufactured by Mitsubishi Chemical Corporation). Examples of commercially available products of the brominated bisphenol A epoxy resin include “jER (registered trademark)” 505, “jER (registered trademark)” 5050, “jER (registered trademark)” 5051, “jER (registered trademark)” 5054 and “jER (registered trademark)” 5057 (which are manufactured by Mitsubishi Chemical Corporation). Examples of commercially available products of the hydrogenated bisphenol A epoxy resin include ST5080, ST4000D, ST4100D and ST5100 (which are manufactured by Nippon Steel Chemical Co., Ltd.).

Examples of commercially available products of bisphenol F epoxy resins include “jER (registered trademark)” 806, “jER (registered trademark)” 807, “jER (registered trademark)” 4002P, “jER (registered trademark)” 4004P, “jER (registered trademark)” 4007P, “jER (registered trademark)” 4009P and “jER (registered trademark)” 4010P (which are manufactured by Mitsubishi Chemical Corporation), and “Epotohto (registered trademark)” YDF2001 and “Epotohto (registered trademark)” YDF2004 (which are manufactured by Nippon Steel Chemical Co., Ltd.). An example of a commercially available product of the tetramethyl-bisphenol F epoxy resin is YSLV-80XY (manufactured by Nippon Steel Chemical Co., Ltd.).

An example of a bisphenol S epoxy resin is “Epiclon (registered trademark)” EXA-154 (manufactured by DIC Corporation).

Examples of commercially available products of tetraglycidyl diaminodiphenyl methane resins include “Sumiepoxy (registered trademark)” ELM434 (manufactured by Sumitomo Chemical Co., Ltd.), YH434L (manufactured by Nippon Steel Chemical Co., Ltd.), “jER (registered trademark)” 604 (manufactured by Mitsubishi Chemical Corporation), and “Araldite (registered trademark)” MY720 and MY721 (which are manufactured by Huntsman Advanced Materials). Examples of commercially available products of triglycidyl aminophenol or triglycidyl aminocresol resins include “Sumiepoxy (registered trademark)” ELM100 (manufactured by Sumitomo Chemical Co., Ltd.), “Araldite (registered trademark)” MY0500, MY0510 and MY0600 (which are manufactured by Huntsman Advanced Materials) and “jER (registered trademark)” 630 (manufactured by Mitsubishi Chemical Corporation).

Examples of commercially available products of tetraglycidyl xylylenediamine and hydrogenated products thereof include TETRAD-X and TETRAD-C (which are manufactured by Mitsubishi Gas Chemical Company, Inc.).

Examples of commercially available products of phenol-novolac epoxy resins include “jER (registered trademark)” 152 and “jER (registered trademark)” 154 (which are manufactured by Mitsubishi Chemical Corporation), and “Epiclon (registered trademark)” N-740, N-770 and N-775 (which are manufactured by DIC Corporation).

Examples of commercially available products of cresol-novolac epoxy resins include “Epiclon (registered trademark)” N-660, N-665, N-670, N-673 and N-695 (which are manufactured by DIC Corporation), and EOCN-1020, EOCN-102S and EOCN-104S (which are manufactured by Nippon Kayaku Co., Ltd.).

An example of a commercially available product of a resorcinol epoxy resin is “Denacol (registered trademark)” EX-201 (manufactured by Nagase chemteX Corporation).

Examples of commercially available products of naphthalene epoxy resins include HP-4032, HP4032D, HP-4700, HP-4710, HP-4770, EXA-4701, EXA-4750, EXA-7240 (which are manufactured by DIC Corporation)

Examples of commercially available products of dicyclopentadiene epoxy resins include “Epiclon (registered trademark)” HP7200, HP7200L, HP7200H and HP7200HH (which are manufactured by DIC Corporation), “Tactix (registered trademark)” 558 (manufactured by Huntsman Advanced Material), and XD-1000-1L and XD-1000-2L (which are manufactured by Nippon Kayaku Co., Ltd.).

Examples of commercially available products of epoxy resins having a biphenyl skeleton include “jER (registered trademark)” YX4000H, YX4000 and YL6616 (which are manufactured by Mitsubishi Chemical Corporation), and NC-3000 (manufactured by Nippon Kayaku Co., Ltd.).

Examples of commercially available products of isocyanate-modified epoxy resins include AER4152 (manufactured by Asahi Kasei Epoxy Co., Ltd.) and ACR1348 (manufactured by ADEKA Corporation) each of which has an oxazolidone ring.

The thermosetting resin may comprise both a tetrafunctional epoxy resin (in particular, a tetraglycidyldiaminodiphenyl methane epoxy resin) and a difunctional glycidylamine, in particular a difunctional glycidyl aromatic amine such as glycidyl aniline or glycidyl toluidine from the view point of the required resin modulus. A difunctional epoxy resin, such as a difunctional bisphenol A or F/epichlorohydrin epoxy resin could be used to provide an increase in a flexural deflection of the cured adhesive composition; the average epoxy equivalent weight (EEW) of the difunctional epoxy resin may be, for example from 177 to 1500, for example. For example, the thermosetting resin may comprise 50 to 70 weight % tetrafunctional epoxy resin, 10 to 30 weight percent difunctional bisphenol A or F/epichlorohydrin epoxy resin, and 10 to 30 weight percent difunctional glycidyl aromatic amine.

The adhesive composition also includes a curing agent or a cross-linker compound. There are no specific limitations or restrictions on the choice of a compound as the curing agent, as long as it has at least one active group which reacts with the thermosetting resin and collectively provides the required resin modulus and/or promotes adhesion.

For the above epoxy resins, examples of suitable curing agents include polyamides, dicyandiamide [DICY], amidoamines (e.g., aromatic amidoamines such as aminobenzamides, aminobenzanilides, and aminobenzenesulfonamides), aromatic diamines (e.g., diaminodiphenylmethane, diaminodiphenylsulfone [DDS]), aminobenzoates (e.g., trimethylene glycol di-p-aminobenzoate and neopentyl glycol di-p-amino-benzoate), aliphatic amines (e.g., triethylenetetramine, isophoronediamine), cycloaliphatic amines (e.g., isophorone diamine), imidazole derivatives, guanidines such as tetramethylguanidine, carboxylic acid anhydrides (e.g., methylhexahydrophthalic anhydride), carboxylic acid hydrazides (e.g., adipic acid hydrazide), phenol-novolac resins and cresol-novolac resins, carboxylic acid amides, polyphenol compounds, polysulfides and mercaptans, and Lewis acids and bases (e.g., boron trifluoride ethylamine, tris-(diethylaminomethyl) phenol). Depending on the desired properties of the cured fiber reinforced epoxy composition, a suitable curing agent or suitable combination of curing agents is selected from the above list. For example, if dicyandiamide is used, it will generally provide the product with good elevated-temperature properties, good chemical resistance, and a good combination of tensile and peel strength. Aromatic diamines, on the other hand, will typically give moderate heat and chemical resistance and high modulus. Aminobenzoates will generally provide excellent tensile elongation though they often provide inferior heat resistance compared to aromatic diamines. Acid anhydrides generally provide the resin matrix with low viscosity and excellent workability, and subsequently, high heat resistance after curing. Phenol-novolac resins and cresol-novolac resins provide moisture resistance due to the formation of ether bonds, which have excellent resistance to hydrolysis. Note that a mixture of two or more above curing agents could be employed. For example, by using DDS together with DICY as the hardener, the reinforcing fiber and the adhesive composition could adhere more firmly, and in particular, the heat resistance, the mechanical properties such as compressive strength, and the environmental resistance of the fiber reinforced composite material obtained may be markedly enhanced. In another example when DDS is combined with an aromatic amidoamine (e.g., 3-aminobenzamide), an excellent balance of thermal, mechanical properties and environmental resistance could be achieved.

The curing agent in the invention may comprise at least an amide group and an aromatic group, wherein the amide group is selected from an organic amide group, a sulfonamide group or a phosphoramide group, or collectively their combinations. The amide group provides not only improved adhesion of the adhesive composition to the reinforcing fiber, but also promotes high resin modulus without penalizing strain due to hydrogen bond formations. The curing agent additionally comprises one or more curable functional groups such as nitrogen-containing groups (e.g., an amine group), a hydroxyl group, a carboxylic acid group, and an anhydride group. Amine groups in particular tend to provide higher crosslink density and hence improved resin modulus. A curing agent having at least an amide group and an amine group is herein referred to as an ‘amidoamine’ curing agent. Curing agents having a chemical structure which comprises at least an aromatic group, an amide group and an amine group are referred to herein as “aromatic amidoamines.” Generally speaking, increasing the number of benzene rings that an aromatic amidoamine has tends to result in a higher resin modulus.

The additional curable functional group and/or the amide group may be substituted on an aromatic ring. Aromatic amidoamines, for example, are suitable for use as the curing agent in the present invention. Examples of the above-mentioned curing agents include, but are not limited to, benzamides, benzanilides, and benzenesulfonamides (including not only the base compounds but substituted derivatives, such as compounds wherein the nitrogen atom of the amide group and/or the benzene ring is substituted with one or more substituents such as alkyl groups, aryl groups, aralkyl groups, non-hydrocarbyl groups and the like), aminobenzamides and derivatives or isomers thereof, including compounds such as anthranilamide (o-aminobenzamide, 2-aminobenzamide), 3-aminobenzamide, 4-aminobenzamide, aminoterephthalamides and derivatives or isomers thereof such as 2-aminoterephthalamide, N,N′-Bis(4-aminophenyl) terephthalamide, diaminobenzanilides and derivatives or isomers thereof such as 2,3-diaminobenzanilide, 3,3-diaminobenzanilide, 3,4-diaminobenzanilide, 4,4-diaminobenzanilide, aminobenzenesulfonamides and derivatives or isomers thereof such as 2-aminobenzenesulfonamide, 3-aminobenzenesulfonamide, 4-aminobenzenesulfonamide (sulfanilamide), 4-(2-aminoethyl)benzenesulfonamide, and N-(phenylsulfonyl)benzenesulfonamide, and sulfonylhydrazides such as p-toluenesulfonylhydrazide. Among the aromatic amidoamine curing agents, aminobenzamides, aminoterephthalamides, diaminobenzanilides, and aminobenzenesulfonamides are suitable to provide excellent resin modulus and ease of processing.

Another method to achieve the required resin modulus could be to use a combination of the above epoxy resins and benzoxazine resins. Examples of suitable benzoxazine resins include, but are not limited to, multi-functional n-phenyl benzoxazine resins such as phenolphthaleine based, thiodiphenyl based, bisphenol A based, bisphenol F based, and/or dicyclopentadiene based benzoxazines. When an epoxy resin or a mixture of epoxy resins with different functionalities is used with a benzoxazine resin or a mixture of benzoxazine resins of different kinds, the weight ratio of the epoxy resin(s) to the benzoxazine resin(s) could be between 0.01 and 100. Yet another method is to incorporate high modulus additives into the adhesive composition. Examples of high modulus additives include, but are not limited to, oxides (e.g., silica), clays, polyhedral oligomeric silsesquioxanes (POSS), carbonaceous materials (e.g., carbon nanotubes with and without substantial alignment, carbon nanoplatelets, carbon nanofibers, fibrous materials (e.g., nickel nanostrand, halloysite), ceramics, silicon carbides, diamonds, and mixtures thereof.

The adhesive composition is required to contain an interfacial material. There are no specific limitations or restrictions on the choice of a compound as the interfacial material, as long as it can migrate to the vicinity of the reinforcing fiber and preferably stays there due to its surface chemistry being more compatible with the substances on the reinforcing fiber than with the substances present in the bulk adhesive composition and subsequently becomes a part of the interphase. The interfacial material comprises at least one material selected from the group consisting of polymers, core-shell particles, inorganic materials, metals, oxides, carbonaceous materials, organic-inorganic hybrid materials, polymer grafted inorganic materials, organofunctionalized inorganic materials, polymer grafted carbonaceous materials, organofunctionalized carbonaceous materials and combinations thereof. The interfacial material is insoluble or partially soluble in the adhesive composition after the adhesive composition is cured.

Depending on the desired function of the interphase, a suitable interfacial material is selected. For example, soft interfacial materials such as core-shell particles could provide both dramatic improvement in tensile strength and mode I fracture toughness while harder interfacial material such as oxide particles increase both compressive properties and tensile strength. The interfacial material can be used in an amount up to 50 weight parts per 100 weight parts of the thermosetting resin (50 phr). Lower amounts could be used to control interfacial properties such as fracture toughness and stiffness affecting tensile-related, adhesion-related and compressive properties without influencing the bulk adhesive composition's properties that might drive these properties in a negative direction. In one embodiment, the interfacial material is present in an amount which is no more than about 30 weight parts per 100 weight parts of the thermosetting resin. An example is core-shell rubber, which may be used in an amount of about 5 phr for the interphase to avoid having an excessive amount of this material in the bulk resin, which causes a reduction in resin modulus and in turn affects compressive properties. To the contrary, high amounts of interfacial material could be used to increase both the interfacial properties and the bulk adhesive composition's properties. For example, silica can be used at an amount of 25 phr to substantially increase both interfacial modulus and the resin modulus, leading to a substantial envelope performance in the direction of compressive properties.

The interphase of the cured fiber reinforced polymer composition could be formed more robustly when a migrating agent is presented in the adhesive composition. The migrating agent herein is any material inducing one or more components in the adhesive composition to be more concentrated in an interfacial region between the fiber and the adhesive composition upon curing of the adhesive composition. This phenomenon is a migration process of the interfacial material to the vicinity of the fiber, which hereafter is referred to as particle migration or interfacial material migration. In such a case, it is said that the interfacial material is more compatible with the reinforcing fiber than the migration agent. Compatibility refers to chemically like molecules, or chemically alike molecules, or molecules whose chemical makeup comprises similar atoms or structure, or molecules that associate with one another and possibly chemically interact with one another. Compatibility implies solubility of one component in another component and/or reactivity of one component with another component. “Not compatible/incompatible” or “does not like” refers to a phenomenon wherein the migrating agent, when present at a certain amount (concentration) in the adhesive composition, causes the interfacial material, which in the absence of the migrating agent would have been uniformly distributed in the adhesive composition after curing, to be not uniformly distributed to some extent.

Any material found more concentrated in a vicinity of the fiber than further away from the fiber or present in the interfacial region or the interphase between the fiber's surface to a definite distance into the cured adhesive composition constitutes an interfacial material in the present adhesive composition. Note that one interfacial material can play the role of a migrating agent for another interfacial agent if it can cause the second interfacial material to have a higher concentration in a vicinity of the fiber than further away from the fiber upon curing of the adhesive composition.

The migrating agent may comprise a polymer, a thermoplastic resin, a thermosetting resin, or a combination thereof. In one embodiment of the invention, the migrating agent is a thermoplastic polymer or combination of thermoplastic polymers. Typically, the thermoplastic polymer additives are selected to modify the viscosity of the thermosetting resin for processing purposes, and/or enhance its toughness, and yet could affect the distribution of the interfacial material in the adhesive composition to some extent. The thermoplastic polymer additives, when present, may be employed in any amount up to 50 parts by weight per 100 parts of the thermosetting resin (50 phr), or up to 35 phr for ease of processing. Typically, the adhesive composition contains no more than about 35 weight parts (e.g., from about 5 to about 35 parts by weight) migrating agent per 100 parts by weight of the thermosetting resin. A suitable amount is determined based on its migrating-driving ability versus mobility of the interfacial material restricted by viscosity of the adhesive composition. Note that when the viscosity of the adhesive composition is adequately low, a uniform distribution of the interfacial material in the adhesive composition might not be necessary to promote particle migration onto or near the fiber's surface. As the viscosity of the adhesive composition increases to some extent, a uniform distribution of the interfacial material in the adhesive composition could help improve particle migration onto or near the fiber's surface.

For the migrating agent, one could use, but is not limited to, the following thermoplastic materials such as polyvinyl formals, polyamides, polycarbonates, polyacetals, polyphenyleneoxides, poly phenylene sulfides, polyarylates, polyesters, polyamideimides, polyimides, polyetherimides, polyimides having phenyltrimethylindane structure, polysulfones, polyethersulfones, polyetherketones, polyetheretherketones, polyaramids, polyethernitriles, polybenzimidazoles, their derivatives and their mixtures thereof.

One could use as the migrating agent aromatic thermoplastic polymer additives which do not impair the high thermal resistance and high elastic modulus of the resin. The selected thermoplastic polymer additive could be soluble in the resin to a large extent to form a homogeneous mixture. The thermoplastic polymer additives could be compounds having aromatic skeletons which are selected from the group consisting of polysulfones, polyethersulfones, polyamides, polyamideimides, polyimides, polyetherimides, polyetherketones, polyetheretherketones, and polyvinyl formals, their derivatives, the alike or similar polymers, and mixtures thereof. Polyethersulfones and polyetherimides and mixtures thereof could be of interest due to their exceptional migrating-drive abilities. Suitable polyethersulfones, for example, may have a number average molecular weight of from about 10,000 to about 75,000.

When both migrating agent and interfacial material are present in the adhesive compositions, the migrating agent and the interfacial material may be present in a weight ratio of migrating agent to interfacial material of from about 0.1 to about 30, or from about 0.1 to about 20. This range is necessary for particle migration and subsequently the interphase formation.

In the invention, the interfacial region between the reinforcing fiber and the adhesive composition comprises at least the interfacial material to form a reinforced interphase necessary to reduce stress concentration in this region and allow a substantially improved envelope performance of the cured reinforced polymer composition, which could not be achieved without such a reinforced interphase. In order to create the reinforced interphase it is required to have a reinforcing fiber providing a compatible surface chemistry to the surface chemistry of the interfacial material and the migration process is further driven by the migrating agent. The interfacial material is concentrated in-situ in the interfacial region during curing of the adhesive composition such that the interfacial material has a gradient in concentration in the interfacial region, more concentrated when closer to the reinforcing fiber than further away where the migrating agent is present at a higher amount. The composition of the reinforced interphase could be very unique for each fiber reinforced polymer composition to achieve the observed properties, even though this may not be capable of being quantitatively documented due to the limitations of current state-of-the-art analytical instruments, and yet presumably comprises functional groups on the fiber surface or surface chemistry, sizing material, interfacial material, and other component(s) in the bulk resin that could migrate into the vicinity of the reinforcing fibers. For carbon fibers in particular, surface functional groups might depend on the modulus of carbon fibers, their surface characteristics, and the type of surface treatment used.

The adhesive composition may optionally include an accelerator. There are no specific limitations or restrictions on the choice of a compound as the accelerator, as long as it can accelerate reactions between the resin and the curing agent and does not deteriorate the effects of the invention. Examples include urea compounds, sulfonate compounds, boron trifluoride piperidine, p-t-butylcatechol, sulfonate compounds (e.g., ethyl p-toluenesulfonate or methyl p-toluenesulfonate), a tertiary amine or a salt thereof, an imidazole or a salt thereof, phosphorus curing accelerators, metal carboxylates and a Lewis or Bronsted acid or a salt thereof.

Examples of such a urea compound include N,N-dimethyl-N′-(3,4-dichlorophenyl) urea, toluene bis(dimethylurea), 4,4′-methylene bis(phenyl dimethylurea), and 3-phenyl-1,1-dimethylurea. Commercial products of such a urea compound include DCMU99 (manufactured by Hodogaya Chemical Co., Ltd.), and Omicure (registered trademark) 24, 52 and 94 (all manufactured by CVC Specialty Chemicals, Inc.).

Commercial products of an imidazole compound or derivative thereof include 2MZ, 2PZ and 2E4MZ (all manufactured by Shikoku Chemicals Corporation). Examples of a Lewis acid catalyst include complexes of a boron trihalide and a base, such as a boron trifluoride piperidine complex, boron trifluoride monoethyl amine complex, boron trifluoride triethanol amine complex, boron trichloride octyl amine complex, methyl p-toluenesulfonate, ethyl p-toluenesulfonate and isopropyl p-toluenesulfonate.

The adhesive composition optionally may contain additional additives such as a toughening agent/filler, an interlayer toughener, or a combination thereof to further improve mechanical properties such as toughness or strength or physical/thermal properties of the cured fiber reinforced polymer composition as long as the effects of the present invention are not deteriorated.

One or more polymeric and/or inorganic toughening agents/fillers can be used. The toughening agent may be uniformly distributed in the form of particles in the cured fiber reinforced polymer composition. The particles could be less than 5 microns in diameter, or even less than 1 micron in diameter. The shortest dimension of the particles could be less than 300 nm. When a toughening agent is needed to toughen the thermosetting resin in the fiber bed, the longest dimension of the particles could be no more than 1 micron. Such toughening agents include, but are not limited to, elastomers, branched polymers, hyperbranched polymers, dendrimers, rubbery polymers, rubbery copolymers, block copolymers, core-shell particles, oxides or inorganic materials such as clay, polyhedral oligomeric silsesquioxanes (POSS), carbonaceous materials (e.g., carbon black, carbon nanotubes, carbon nanofibers, fullerenes), ceramics and silicon carbides, with or without surface modification or functionalization. Examples of block copolymers include the copolymers whose composition is described in U.S. Pat. No. 6,894,113 (Court et al., Atofina, 2005) and include “Nanostrength®” SBM (polystyrene-polybutadiene-polymethacrylate), and AMA (polymethacrylate-polybutylacrylate-polymethacrylate), both produced by Arkema. Other suitable block copolymers include Fortegra® and the amphiphilic block copolymers described in U.S. Pat. No. 7,820,760B2, assigned to Dow Chemical. Examples of known core-shell particles include the core-shell (dendrimer) particles whose compositions are described in US20100280151A1 (Nguyen et al., Toray Industries, Inc., 2010) for an amine branched polymer as a shell grafted to a core polymer polymerized from polymerizable monomers containing unsaturated carbon-carbon bonds, core-shell rubber particles whose compositions are described in EP 1632533A1 and EP 2123711A1 by Kaneka Corporation, and the “KaneAce MX” product line of such particle/epoxy blends whose particles have a polymeric core polymerized from polymerizable monomers such as butadiene, styrene, other unsaturated carbon-carbon bond monomer, or their combinations, and a polymeric shell compatible with the epoxy, typically polymethylmethacrylate, polyglycidylmethacrylate, polyacrylonitrile or similar polymers. Also suitable as block copolymers in the present invention are the “JSR SX” series of carboxylated polystyrene/polydivinylbenzenes produced by JSR Corporation; “Kureha Paraloid” EXL-2655 (produced by Kureha Chemical Industry Co., Ltd.), which is a butadiene alkyl methacrylate styrene copolymer; “Stafiloid” AC-3355 and TR-2122 (both produced by Takeda Chemical Industries, Ltd.), each of which are acrylate methacrylate copolymers; and “PARALOID” EXL-2611 and EXL-3387 (both produced by Rohm & Haas), each of which are butyl acrylate methyl methacrylate copolymers. Examples of suitable oxide particles include Nanopox® produced by nanoresins AG. This is a master blend of functionalized nanosilica particles and an epoxy.

The interlayer toughener could be thermoplastics, elastomers, or combinations of an elastomer and a thermoplastic, or combinations of an elastomer and an inorganic such as glass, or pluralities of nanofibers or micronfibers. If the interlayer toughener is a particulate, the average particle size of interlayer tougheners could be no more than 100 μm, or 10-50 μm, to keep them in the interlayer after curing to provide maximum toughness enhancement. The particles are said to be localized outside of a plurality of the reinforcing fibers. Such particles are generally employed in amounts of up to about 30%, or up to about 15% by weight (based upon the weight of total resin content in the composite composition). Examples of suitable thermoplastic materials include polyamides. Known polyamide particles include SP-500, produced by Toray Industries, Inc., “Orgasol®” produced by Arkema, and Grilamid® TR-55 produced by EMS-Grivory, nylon-6, nylon-12, nylon 6/12, nylon 6/6, and Trogamid® CX by Evonik. If the toughener has a fibrous form, it can be deposited on either surface of a plurality of the reinforcing fibers impregnated by the adhesive composition. The interlayer toughener could further comprise a curable functional group as defined above that reacts with the adhesive composition. The interlayer toughener could be a conductive material or coated with a conductive material or combination of a conductive material and a non-conductive material to regain z-direction electrical and/or thermal conductivity of the cured fiber reinforced polymer composition that was lost by the introduction of the resin-rich interlayers.

Another embodiment of the invention relates to a fiber reinforced polymer composition comprising a carbon fiber and an adhesive composition, wherein the adhesive composition is comprised of an epoxy resin, an interfacial material comprising a core-shell particle, an amidoamine curing agent and a migrating agent selected from the group consisting of polyethersulfones, polyetherimides, and mixtures thereof, and wherein the interfacial material has a gradient in concentration in an interfacial region between the cured adhesive composition and the carbon fiber.

The carbon fiber is required in this embodiment to provide the cured fiber reinforced polymer composition exceptionally high strength and stiffness as well as light weight. There are no specific limitations or restrictions on the choice of a carbon fiber, as long as the effects of the present invention are not deteriorated. Selection of carbon fibers has been discussed above.

The adhesive composition is also required to have an amidoamine curing agent to provide good bonding of the epoxy in the adhesive composition to the carbon fiber. There are no specific limitations or restrictions on the choice of the amidoamine curing agent and the epoxy as long as the effects of the present invention are not deteriorated. Examples of amidoamine curing agents and epoxy resins were discussed previously.

The adhesive composition includes an interfacial material comprising a core-shell particle and a migrating agent selected from the group consisting of polyethersulfones, polyetherimides, and mixtures thereof. Polyethersulfones and polyethersulfone are selected to promote migration of the core-shell particle and form an interphase robustly. There are no specific limitations or restrictions on the choice of a core-shell particle as long as it has surface chemistry more compatible with that of the carbon fiber than the migrating agent. Examples of core-shell particles are the Kane Ace MX product line of Kaneka Corporation (e.g., MX416, MX125, MX156) or a material having a shell composition or a surface chemistry similar to Kane Ace MX materials or a material having a surface chemistry compatible with the fiber's surface chemistry, which allows the material to migrate to the vicinity of the fiber and provide a higher concentration of the material in the vicinity of the fiber than in the bulk adhesive composition. These core-shell particles are typically well dispersed in an epoxy base material at a typical loading of 25% and are ready to be used in the adhesive composition for high performance bonds to the fibers.

The selection of elements in the above embodiment leads to a soft interphase with a very unique composition, even though this may not be capable of being quantitatively documented due to the limitations of current state-of-the-art analytical instruments, and yet presumably comprises functional groups on the carbon fiber surface, sizing material, core-shell particle material, and other component(s) in the bulk resin that could migrate into the vicinity of the reinforcing fibers. Such a composition or an equivalent and best-estimate composition could have a critical stress intensity factor K_{IC} equal to or higher than that of the bulk adhesive composition and of at least 0.3 MPa·m^{0.5}, at least 0.5 MPa·m^{0.5}, at least 0.7 MPa·m^{0.5} or even at least 1 MPa·m^{0.5}. The cured fiber reinforced polymer composition tends to have exceptionally high tensile strength and mode I fracture toughness without penalizing compressive properties, owning to the soft interphase.

The adhesive composition might further comprise an accelerator, a toughening agent, a filler, an interlayer toughener, or a combination thereof as long as the effects of the invention are not deteriorated. Selections of these components were described previously.

Another embodiment of the invention relates to a fiber reinforced polymer composition comprising a reinforcing fiber and an adhesive composition, wherein the adhesive composition comprises at least a thermosetting resin, a curing agent and an interfacial material, wherein the interfacial material has a gradient in concentration in an interfacial region between the cured thermosetting resin and the reinforcing fiber, and the cured fiber reinforced polymer simultaneously achieves a tensile strength of at least 80% translation, a compression strength of at least 1380 MPa (200 ksi), and mode I fracture toughness of at least 350 J/m² (2 lb·in/in²).

In this embodiment, a reinforcing fiber is required. There are no specific limitations or restrictions on the choice of a reinforcing fiber as long as the effects of the present invention are not deteriorated. Examples contain carbon fibers, organic fibers such as aramid fibers, silicon carbide fibers, metal fibers (e.g., alumina fibers), boron fibers, tungsten carbide fibers, glass fibers, and natural/bio fibers. Such reinforcing fiber is required to have a non-polar surface energy at 30° C. of at least 30 mJ/m², at least 40 mJ/m², or even at least 50 mJ/m² and/or a polar surface energy at 30° C. of at least 2 mJ/m², at least 5 mJ/m², or even at least 10 mJ/m². This condition is one of the necessary requirements to form an interphase and promote good bonds.

In cases when the reinforcing fiber is a carbon fiber, instead of using surface energies as described above for selecting suitable carbon fibers for concentrating the interfacial material, an interfacial shear strength (IFSS) value of at least 20 MPa, at least 25 MPa, or even at least 30 MPa may be achieved. In order to achieve such high IFSS, the carbon fiber is desired to have an O/C concentration is at least 0.05, at least 0.1, or even at least 0.15. The oxidized carbon fiber is coated with a sizing material. Both the O/C concentration on the surface of the carbon fiber and the sizing material collectively are specific to promote adhesion of the adhesive composition to the carbon fiber. There is no restriction on the choice of the sizing material as long as the requirements of surface energies for an interphase formation are met and/or the sizing promotes good bonds.

The cured adhesive composition is also required to include a thermosetting resin, a curing agent, and an interfacial material. There are no specific limitations or restrictions on the choice of these components as long as the effects of the present invention are not deteriorated. Examples of these components were described previously.

In addition to the above, the interfacial region between the reinforcing fiber and the adhesive composition comprises at least the interfacial material to form a reinforced interphase necessary to reduce stress concentration in this region and allow a substantially improved envelope performance of the cured reinforced polymer composition, which could not be achieved without such a reinforced interphase. In order to create the reinforced interphase it is required to have the reinforcing fiber provide a compatible surface chemistry to the surface chemistry of the interfacial material. The interfacial material is concentrated in-situ in the interfacial region during curing of the adhesive composition such that the interfacial material has a gradient in concentration in the interfacial region, i.e., more concentrated closer to the reinforcing fiber than further away. The resulting cured fiber reinforced polymer with the reinforced interphase could have at least 80% translation of tensile strength, at least 1380 MPa (200 ksi) of compression strength and at least 350 J/m² (2 lb·in/in²) of mode I fracture toughness.

In another embodiment, a fiber reinforced polymer composition, either a thermosetting resin or a curing agent or both could contain at least an amide group to provide both high resin modulus and exceptional adhesion to the reinforcing fibers. The amide group when incorporated in a cured epoxy network could increase resin modulus without penalizing significant strain due to hydrogen bond formations. Such a thermosetting agent, curing agent or additive(s) comprising the amide group or other groups having the aforementioned characteristics is referred to herein as an epoxy fortifying agent or an epoxy fortifier. In such a case a resin modulus of at least about 4.0 GPa and a flexural deflection of at least about 4 mm could be observed. Such systems are important to improve both compressive as well as fracture toughness properties of the fiber reinforced polymer composition. Increasing the number of benzene rings that such a compound has generally leads to a higher resin modulus. In addition, in another embodiment an isomer of either the thermosetting or the curing agent can be used. Isomers herein in the invention refer to compounds comprising identical number of atoms and groups, wherein the locations of one or more groups are different. For example, the amide group and the amine group of an aminobenzamide could be located relative to each other on a benzene ring at ortho (1, 2), meta (1, 3), or para (1, 4) positions to form 2-aminobenzamide, 3-aminobenzamide, and 4-aminobenzamide, respectively. Placing the groups at positions which are ortho or meta to each other tends to result in a higher resin modulus as compared to the resin modulus obtained when the groups are positioned para to each other.

In all embodiments relate to the above fiber reinforced polymer compositions, the curing agent(s) are employed in an amount up to about 75 parts by weight per 100 parts by weight of total thermosetting resin (75 phr). The curing agent might also be used in an amount higher or lower than a stoichiometric ratio between the thermosetting resin equivalent weight and the curing agent equivalent weight to increase resin modulus or glass transition temperature or both. In such cases, an equivalent weight of the curing agent is varied by the number of reaction sites or active hydrogen atoms and is calculated by dividing its molecular weight by the number of active hydrogen atoms. For example, an amine equivalent weight of 2-aminobenzamide (molecular weight of 136) could be 68 for 2 functionality, 45.3 for 3 functionality, 34 for 4 functionality, 27.2 for 5 functionality.

There are no specific limitations or restrictions on the choice of a method of making a fiber reinforced polymer composition as long as the effects of the present invention are not deteriorated.

In one embodiment, for example, a method of making a fiber reinforced polymer composition, comprising combining a reinforcing fiber and an adhesive composition, wherein the adhesive composition comprises at least a thermosetting resin, a curing agent and an interfacial material, the adhesive composition when cured has a resin modulus of at least about 4.0 GPa and forms good bonds to the reinforcing fiber, the reinforcing fiber is suitable for concentrating the interfacial material in an interfacial region between the reinforcing fiber and the adhesive composition, and the interfacial region comprises the interfacial material.

In another embodiment, a fiber reinforced polymer composition may be prepared by a method comprising impregnating a carbon fiber with an adhesive composition comprised of an epoxy resin, an interfacial material comprising a core-shell particle, an amidoamine curing agent and a migrating agent selected from the group consisting of polyethersulfones, polyetherimides, and combinations thereof, wherein the interfacial material is concentrated in-situ in an interfacial region during curing of the epoxy resin such that the interfacial material has a gradient in concentration in the interfacial region, and the interfacial material has a higher concentration in a vicinity of the carbon fiber than further away from the carbon fiber.

Another embodiment relates to a method to create a reinforced interphase in a fiber reinforced polymer composition, wherein a resin infusion method with a low resin viscosity is utilized. In such a case, a migrating agent is concentrated outside a fiber fabric and/or a fiber mat that is stacked to make a desired reform. An adhesive composition comprising at least a thermosetting resin, a curing agent, and an interfacial material is pressurized and infiltrated into the reform, allowing some of the migrating agent to partially mix with the adhesive composition during the infiltration process and penetrate the reform. By having some of the migrating agent in the adhesive composition, the reinforced interphase could be formed during cure of the fiber reinforced polymer composition. The remainder of the migrating agent is concentrated in the interlayer between two fabric sheets or mats and could improve the impact and damage resistance of the fiber reinforced polymer composition. Thermoplastic particles with an average size less than 50 μM could be used as the migrating agent. Examples of such thermoplastic materials include but are not limited to polysulfones, polyethersulfones, polyamides, polyamideimides, polyimides, polyetherimides, polyetherketones, and polyetheretherketones, their derivatives, similar polymers, and mixtures thereof.

The fiber reinforced polymer compositions of the present invention may, for example, be heat-curable or curable at room temperature. In another embodiment, the aforementioned fiber reinforced polymer compositions can be cured by a one-step cure to a final cure temperature, or a multiple-step cure in which the fiber reinforced polymer composition is dwelled (maintained) at a certain dwell temperature for a certain period of dwell time to allow an interfacial material in the fiber reinforced polymer composition to migrate onto the reinforcing fiber's surface, and ramped up and cured at the final cure temperature for a desired period of time. The dwell temperature could be in a temperature range in which the adhesive composition has a low viscosity. The dwell time could be at least about five minutes. The final cure temperature of the adhesive resin composition could be set after the adhesive resin composition reaches a degree of cure of at least 20% during the ramp up. The final cure temperature could be about 220° C. or less, or about 180° C. or less. The fiber reinforced polymer composition could be kept at the final cure temperature until a degree of cure reaches at least 80%. Vacuum and/or external pressure could be applied to the reinforced polymer composition during cure. Examples of these methods include autoclave, vacuum bag, pressure-press (i.e., one side of the article to be cured contacts a heated tool's surface while the other side is under pressurized air with or without a heat medium), or a similar method. Note that other curing methods using an energy source other than thermal, such as electron beam, conduction method, microwave oven, or plasma-assisted microwave oven, or combination could be applied. In addition, other external pressure methods such as shrink wrap, bladder blowing, platens, or table rolling could be used.

For fiber reinforced polymer composites, one embodiment of the present invention relates to a manufacturing method to combine fibers and resin matrix to produce a curable fiber reinforced polymer composition (sometimes referred to as a “prepreg”) which is subsequently cured to produce a composite article. Employable is a wet method in which fibers are soaked in a bath of the resin matrix dissolved in a solvent such as methyl ethyl ketone or methanol, and withdrawn from the bath to remove solvent.

Another suitable method is a hot melt method, where the epoxy resin composition is heated to lower its viscosity, directly applied to the reinforcing fibers to obtain a resin-impregnated prepreg; or alternatively, as another method, the epoxy resin composition is coated on a release paper to obtain a thin film. The film is consolidated onto both surfaces of a sheet of reinforcing fibers by heat and pressure.

To produce a composite article from the prepreg, for example, one or more plies are applied onto a tool surface or mandrel. This process is often referred to as tape-wrapping. Heat and pressure are needed to laminate the plies. The tool is collapsible or removed after cured. Curing methods such as autoclave and vacuum bag in an oven equipped with a vacuum line could be used. A one-step cure cycle or multiple-step cure cycle in that each step is performed at a certain temperature for a period of time could be used to reach a cure temperature of about 220° C. or even 180° C. or less. However, other suitable methods such as conductive heating, microwave heating, electron beam heating and similar methods, can also be employed. In an autoclave method, pressure is provided to compact the plies, while a vacuum-bag method relies on the vacuum pressure introduced to the bag when the part is cured in an oven. Autoclave methods could be used for high quality composite parts. In other embodiments, any methods that provide suitable heating rates of at least 0.5° C./min, at least 1° C./min, at least 5° C./min, or even at least 10° C./min and vacuum and/or compaction pressures by an external means could be used.

Without forming prepregs, the adhesive composition may be directly applied to reinforcing fibers which are conformed onto a tool or mandrel for a desired part's shape, and cured under heat. The methods include, but are not limited to, filament-winding, pultrusion molding, resin injection molding and resin transfer molding/resin infusion, vacuum assisted resin transfer molding.

The resin transfer molding method is a method in which a reinforcing fiber base material is directly impregnated with a liquid thermosetting resin composition and cured. Since this method does not involve an intermediate product, such as a prepreg, it has great potential for molding cost reduction and is advantageously used for the manufacture of structural materials for spacecraft, aircraft, rail vehicles, automobiles, marine vessels and so on.

The filament winding method is a method in which one to several tens of reinforcing fiber rovings are drawn together in one direction and impregnated with a thermosetting resin composition as they are wrapped around a rotating metal core (mandrel) under tension at a predetermined angle. After the wraps of rovings reach a predetermined thickness, it is cured and then the metal core is removed.

The pultrusion method is a method in which reinforcing fibers are continuously passed through an impregnating tank filled with a liquid thermosetting resin composition to impregnate them with the thermosetting resin composition, followed by a squeeze die and heating die for molding and curing, by continuously drawing them using a tensile machine. Since this method offers the advantage of continuously molding fiber-reinforced composite materials, it is used for the manufacture of reinforcement fiber fiber-reinforced plastics (FRPs) for fishing rods, rods, pipes, sheets, antennas, architectural structures, and so on.

Composite articles in the invention are advantageously used in sports applications, general industrial applications, and aerospace and space applications. Concrete sports applications in which these materials are advantageously used include golf shafts, fishing rods, tennis or badminton rackets, hockey sticks and ski poles. Concrete general industrial applications in which these materials are advantageously used include structural materials for vehicles, such as automobiles, bicycles, marine vessels and rail vehicles, drive shafts, leaf springs, windmill blades, pressure vessels, flywheels, papermaking rollers, roofing materials, cables, and repair/reinforcement materials.

Tubular composite articles in the invention are advantageously used for golf shafts, fishing rods, and the like.

### Examination of a Reinforced Interphase

For visual inspection, a high magnification optical microscope or a scanning electron microscope (SEM) could be used to document the failure modes and location/distribution of an interfacial material. The interfacial material could be found on the surface of the fiber along with the adhesive composition after the bonded structure fails. In such cases, mixed mode failure or cohesive failure of the adhesive composition is possible. Good particle migration refers to about 50% or more coverage of the particles on the fiber surface (herein referred to as “particle coverage”), no particle migration refers to less than about 5% coverage, and some particle migration refers to about 5-50% coverage. While a particle coverage of at least 50% is needed to simultaneously improve a wide range of mechanical properties of the fiber reinforced polymer composites, in some cases a particle coverage of at least 10% or even at least 20% is suitable to improve some certain desired properties.

Several methods are known to one skilled in the art to examine and locate the presence of the interfacial material through thickness. An example is to cut the composite structure at 90°, 45° with respect to the fiber's direction. The cut cross-section is polished mechanically or by an ion beam such as argon, and examined under a high magnification optical microscope or electron microscope. SEM is one possible method. Note that in the case where SEM cannot observe the interphase, other available state-of-the-art instruments could be used to document the existence of the interphase and its thickness through another electron scanning method such as TEM, chemical analyses (e.g., X-ray photoelectron spectroscopy (XPS), Time-of-Flight Secondary Ion Mass Spectrometry (ToF-SIMS), infrared (IR) spectroscopy, Raman, the alike or similar) or mechanical properties (e.g., nanoindentation, atomic force microscopy (AFM)), or a similar method.

An interfacial region or an interphase where the interfacial material is concentrated can be observed and documented. The interphase is typically measured from the fiber's surface to a definite distance away where the interfacial material is no longer concentrated compared to the concentration of the interfacial material in the surrounding resin-rich areas. Depending on the amount of the cured adhesive found between two fibers, the interphase could be extended up to 100 micrometers, comprising one or more layers of the interfacial material of one or more different kinds. The interphase thickness could be up to about 1 fiber diameter, comprising one or more layers of the interfacial material of one or more different kinds. The thickness could be up to about ½ of the fiber diameter.

### Examples

Next, certain embodiments of the invention are illustrated in detail by means of the following examples using the following components:

| Component | Product name | Manufacturer | Description |
|---|---|---|---|
| Thermosetting | ELM434 | Sumitomo Chemical | Tetra glycidyl diamino diphenyl |
| | | Co., Ltd. | methane with a functionality of 4, |
| | | | having an average EEW of 120 |
| | | | (ELM434) |
| | Epon ® 828 | Momentive | Difunctional bisphenol A/ |
| | | Specialty Chemicals | epichlorohydrin, having an average |
| | | | EEW of 188 (EP828) |
| | Epon ® 825 | Momentive | Diglycidyl ether of bisphenol A |
| | | | with a functionality of 2, having an |
| | | | average EEW of 177 (EP25) |
| | Epiclon ® 830 | Dainippon Ink and | Diglycidyl ether of bisphenol F |
| | | Chemicals, Inc. | with a functionality of 2, having an |
| | | | average EEW of 177 (EPc830) |
| | Epon ® 1001 | Momentive | Diglycidyl ether of bisphenol A |
| | | | with a functionality of 2, having an |
| | | | average EEW of 537 (EP1001) |
| | Epon ® 2005 | Momentive | Diglycidyl ether of bisphenol A |
| | | | with a functionality of 2, having an |
| | | | average EEW of 1300 (EP2005) |
| | GAN | Nippon Kayaku | Diglycidylaniline with a |
| | | K.K. | functionality of 2 and having an |
| | | | average EEW of 166 (GAN) |
| | Araldite ® EPN | Huntsman Advanced | Epoxy phenol novolac with a |
| | 1138 | Materials | functionality of 3.6 and having an |
| | | | average EEW of 179 (EPN1138) |
| | D.E.N. ™ 439 | The Dow Chemical | Epoxy novolac, epichlorohydrin |
| | | Company | and phenol-formaldehyde novolac |
| | | | with a functionality of 3.8 and |
| | | | having an average EEW of 200 |
| | | | (DEN439) |
| | F-a Type | Shikoku Chemicals | Bisphenol-F benzoxazine Type 1, |
| | benzoxazine | Corporation | equivalent weight 217 (BOX-F) |
| Migrating | Sumikaexcel ® | Sumitomo Chemical | Polyethersulfone, MW 38,200 |
| agent | PES5003P | Co., Ltd. | (PES1) |
| | VW-10700RP | Solvay | Polyethersulfone, MW 21,000 |
| | | | (PES2) |
| | Ultem ® 1000P | Sabic | Polyetherimide (PEI) |
| | Vinylec ™ type K | Chisso Corporation | Polyvinyl formal (PVF) |
| Thermoplastic | Grilamid TR55 | EMS-Grivory | Polyamide (PA) |
| particle | | | |
| Curing agent | Aradur ® 9664-1 | Huntsman Advanced | 4,4′-diaminodiphenyl sulfone (4,4- |
| | | Materials | DDS) |
| | Aradur ® 9719-1 | | 3,3′-diaminodiphenyl sulfone (3,3- |
| | | | DDS) |
| | Anthranilamide | Sigma Aldrich | 2-Aminobenzamide or |
| | | | anthranilamide (AAA) |
| | Sulfanilamide | Sigma Aldrich | p-Aminobenzenesulfonamide |
| | | | (SAA) |
| | 4,4′- | Sigma Aldrich | 4,4′-Diaminobenzanilide (DABA) |
| | Diaminobenzanilide | | |
| | Dyhard ® 100S | Alz Chem Trostberg | Dicyandiamide (DICY) |
| | | GmbH) | |
| Accelerator | Dyhard ® UR200 | Alz Chem Trostberg | 3-(3,4-dichlorophenyl)-1,1- |
| | | GmbH | dimethyl urea (UR200) |
| | U-24 | CVC Thermoset | 2,4-toluene bis-dimethyl urea (U- |
| | | Specialties, an | 24) |
| | | Emerald | |
| | | Performance | |
| | | Materials Company | |
| | Ethyl p- | Sigma Aldrich | Ethyl p-toluenesulfonate (EPTS) |
| | toluenesulfonate | | |
| Interfacial | Kane Ace MX416 | Kaneka Texas | 25 wt % core-shell rubber (CSR) |
| material | | Corporation | particles having core composition |
| | | | of polybutadiene (CSR1) in epoxy |
| Carbon fiber | T800SC-24K-10E | Toray Industries, | 24,000 fibers, tensile strength 5.9 |
| | | Inc. | GPa, tensile modulus 290 GPa, |
| | | | tensile strain 2.0%, density 1.8 |
| | | | g/cm³, type-1 sizing for epoxy |
| | | | resin systems (T800S-10) |
| | T800GC-24K-31E | Toray Industries, | 24,000 fibers, tensile strength 5.9 |
| | | Inc. | GPa, tensile modulus 290 GPa, |
| | | | tensile strain 2.0%, density 1.8 |
| | | | g/cm³, type-3 sizing for epoxy |
| | | | resin systems (T800G-31). |
| | T700GC-12K-31E | Toray Industries, | 12,000 fibers, tensile strength 4.9 |
| | | Inc. | GPa, tensile modulus 240 GPa, |
| | | | tensile strain 2.0%, density 1.8 |
| | | | g/cm³, type-3 sizing for epoxy |
| | | | resin systems (T700G-31) |
| | T700SC-12K-60E | Toray Industries, | 12,000 fibers, tensile strength 4.9 |
| | | Inc. | GPa, tensile modulus 240 GPa, |
| | | | tensile strain 2.0%, density 1.8 |
| | | | g/cm³, type-6 sizing for epoxy |
| | | | resin systems (T700S-60) |
| | MX-12K-30E | Toray Industries, | 12,000 fibers, tensile strength 4.9 |
| | | Inc. | GPa, tensile modulus 370 GPa, |
| | | | tensile strain 1.2%, density 1.77 |
| | | | g/cm³, type-3 sizing for epoxy resin |
| | | | systems (MX-30) |
| | MX-12K-50C | Toray Industries, | 12,000 fibers, tensile strength 4.9 |
| | | Inc. | GPa, tensile modulus 370 GPa, |
| | | | tensile strain 1.2%, density 1.77 |
| | | | g/cm³, type-5 sizing for epoxy, |
| | | | phenolic, polyester, vinyl ester |
| | | | resin systems (MX-50) |
| | M40JB-6K-50B | Toray Industries, | 6,000 fibers, tensile strength 4.4 |
| | | Inc. | GPa, tensile modulus 370 GPa, |
| | | | tensile strain 1.2%, density 1.77 |
| | | | g/cm³, type-5 sizing for epoxy, |
| | | | phenolic, polyester, vinyl ester |
| | | | resin systems (M40J-50) |

MX fibers were made using a similar PAN precursor in a similar spinning process as T800S fibers. However, to obtain a higher modulus, up to a maximum carbonization temperature of 3000° C. could be applied. For surface treatment and sizing application, similar processes were utilized.

### Examples 1-5 and Comparative Example 1

Examples 1-5 and Comparative Example 1 were prepared as follows, where Comparative Example 1 is the control without a reinforced interphase. Carbon fiber T700G-31 (standard modulus) was used.

Appropriate amounts of epoxies, interfacial material CSR, and migrating agent, in each composition of Examples 1, 3-5 were charged into a mixer preheated at 100° C. After charging, the temperature was increased to 160° C. while the mixture was agitated, and held for 1 hr. After that, the mixture was cooled to 65° C. and the curing agent AAA was charged. The final resin mixture was agitated for 1 hr, then discharged and some was stored in a freezer.

Some of the hot mixture was degassed in a planetary mixer rotating at 1500 rpm for a total of 20 min, and poured into a metal mold with 0.25 in thick Teflon® insert. The resin was heated to 180° C. with the ramp rate of 1.7° C./min, allowed to dwell for 2 hr to complete curing, and finally cooled down to room temperature. Resin plates were prepared for testing according to ASTM D-790 for flexural test, and ASTM D-5045 for fracture toughness test.

To make a prepreg, the hot resin was first cast into a thin film using a knife coater onto a release paper. The film was consolidated onto a bed of fibers on both sides by heat and compaction pressure. A UD prepreg having carbon fiber area weight of about 190 g/m² and resin content of about 35% was obtained. The prepregs were cut and hand laid up using the sequence listed in Table 2 for each type of mechanical test, following an ASTM procedure. Panels were cured in an autoclave at 180° C. for 2 hr with a ramp rate of 1.7° C./min and a pressure of 0.59 MPa. Alternatively, a dwell at about 90° C. for about 45 min could be introduced to promote particle migration before ramping up to 180° C.

The above procedure was repeated for Example 2 with interlayer toughening material PA introduced to the mixer before the curing agent was charged and for Comparative Example 1 without CSR.

As shown, the presence of CSR decreased the resin's flexural modulus as expected versus the control. However, surprisingly, in Example 1, compression strength and interlaminar shear strength of the composite were maintained or improved, due to the formation of the interphase. In addition, fracture toughness and tensile strength were improved significantly. A substantial amount of CSR material and cured resin was found to form a layer on a surface of the fibers as the 0-degree fractured surfaces with respect to the fiber direction were examined. This provides evidence that good particle migration and a cohesive failure in the resin have occurred. The 90 deg cross-sections showed that CSR material was concentrated around the fibers up to a distance of about 0.5 μm. By tailoring the resin chemistry, the fiber surface chemistry and the particle surface chemistry, a very unique interphase was formed, leading to a remarkable performance envelope that has not been documented with any conventional composite system up to date. Similar to previous results, by having a high resin modulus combined with a reinforced interphase in Examples 11-14, simultaneous improvements of tensile strength, compressive strength, interlaminar shear strength without penalizing fracture toughness were observed, compared to the control. The composition of the interphase could be very unique for each system, though could not be quantitatively documented, and presumably comprises functional groups on the fiber surface, sizing material, interfacial material, and other component(s) in the bulk resin that could migrate into the vicinity of the reinforcing fibers. These unique interfacial compositions were thought to be responsible for the improvements.

Example 2 extends Example 1 with an interlayer toughener PA to determine if there are any additional synergistic contributions by this toughener to the overall composite's properties. Surprisingly, this toughener was found to significantly increase mode II fracture toughness (by shear) as opposed to mode I fracture toughness (by tension) without penalizing other properties observed in Example 1.

Example 3 extends Example 1 with a different migrating agent PEI to form a reinforced interphase. Both high resin modulus and particle migration were observed. As a result, similar improvements as shown in Example 1 could be observed.

Examples 4-5 explored different types of curing agent similar to the AAA curing agent, having at least a benzene ring, an amide group, and an amine group. Note that for these samples, a higher molecular weight PES (PES1) was used. As shown, these curing agents can also provide a very high resin modulus; as well, CSR material could migrate onto the fibers' surface. As a result, similar improvements as shown in previous examples could be observed.

### Example 6 and Comparative Examples 2-4

Comparative Examples 2-3 showed the effects of high modulus resin without an interphase and Comparative Example 4 showed the effects of low modulus resin with an interphase, while Example 6 showed the effects of both high modulus resin with an interphase. High modulus carbon fibers were used in these examples.

Resins, prepreg and composite mechanical tests were performed using procedures as in previous examples.

As observed, with the presence of an interphase, tensile strength was improved (Comparative Example 4) at the expense of compressive strength and when a high modulus resin was used, compressive strength was increased (Comparative Examples 2-3). Surprisingly, in Example 6 when both an interphase and a high resin modulus were employed, significant improvements of both tensile and compressive properties were found. The strengths were even higher than if either the interphase or the high modulus resin had been present by itself. In addition, fracture toughness and ILSS were improved remarkably. Similar to previous results, by having a high resin modulus combined with a reinforced interphase in Examples 11-14, simultaneous improvements of tensile strength, compressive strength, and interlaminar shear strength without penalizing fracture toughness were observed, compared to the control.

### Examples 7-10 and Comparative Examples 5-7

Standard modulus carbon fibers were used in these examples. Resins, prepreg and composite mechanical tests were performed using procedures as in previous examples. Note that the accelerators used in these examples were added to each resin system before the curing agent. The controls are Comparative Examples 5-7 without an interphase formation. In addition, the Comparative Example 7 has a low resin modulus with the use of DICY instead of AAA. Note that these systems were cured at 135° C. for 2 hr due to use of accelerators.

Surprisingly, the accelerator used in Example 7 did not affect the particle migration process. With a high resin modulus and a reinforced interphase, this Example showed significant improvements across the composite property spectrum (about 10% or higher for most properties and up to 300% for fracture toughness, compared to Comparative Example 7 with a much lower resin modulus and without a reinforced interphase, or Comparative Example 6 with a similar resin modulus but without a reinforced interphase). Similarly, when compared to its respective control (Comparative Example 5), Example 7 also showed significant improvements. The composition of the interphase could be very unique for each system, though could not be quantitatively documented, and presumably comprises functional groups on the fiber surface, sizing material, interfacial material, and other component(s) in the bulk resin that could migrate into the vicinity of the reinforcing fibers. These unique interfacial compositions were thought to be responsible for the improvements.

Examples 8-10 explored different types of accelerator to be used with the AAA curing agent. Note that Example 8 uses the migrating agent PEI instead of PES. As shown, these accelerators could provide a very high resin modulus without penalizing good particle migration of the CSR material onto the fibers' surface. As a result, similar improvements as shown in Example 7 could be observed.

### Examples 11-14 and Comparative Example 8

Intermediate carbon fibers were used in these examples. Resins, prepreg and composite mechanical tests were performed using procedures as in previous examples. The control is Comparative Example 8 with a reinforced interphase and a low resin modulus. These examples explore another way to increase resin modulus by utilizing a difunctional epoxy resin (GAN) or a benzoxazine resin while forming a reinforced interphase.

Similar to previous results, by having a high resin modulus combined with a reinforced interphase in Examples 11-14, simultaneous improvements of tensile strength, compressive strength, interlaminar shear strength without penalizing fracture toughness were observed, compared to the control. The composition of the interphase could be very unique for each system, though could not be quantitatively documented, and presumably comprises functional groups on the fiber surface, sizing material, interfacial material, and other component(s) in the bulk resin that could migrate into the vicinity of the reinforcing fibers. These unique interfacial compositions were thought to be responsible for the improvements.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

This application discloses several numerical range limitations. The numerical ranges disclosed inherently support any range within the disclosed numerical ranges though a precise range limitation is not stated verbatim in the specification because this invention can be practiced throughout the disclosed numerical ranges. Finally, the entire disclosure of the patents and publications referred in this application are hereby incorporated herein by reference.

TABLE 1

| | | | | | | | | | | | | | Exam- |
|---|---|---|---|---|---|---|---|---|---|---|---|---|---|
| | | | Example | | | | | | C.E. | | | | ple |
| | | | 1 | 2 | 3 | 4 | 5 | 6 | 1 | 2 | 3 | 4 | 7 |
| Resin | Thermosetting | ELM434 | 60 | 60 | 60 | 60 | 60 | 60 | 60 | 60 | 60 | 60 | 60 |
| | | EPON825 | 20 | 20 | 30 | 30 | 30 | 20 | 20 | 20 | 20 | 20 | 0 |
| | | EPc830 | 10 | 10 | 10 | 10 | 10 | 10 | 10 | 10 | 10 | 20 | 0 |
| | | EP1001 | 0 | 0 | 0 | 0 | 0 | 0 | 0 | 0 | 0 | 0 | 0 |
| | | Ep2005 | 10 | 10 | 0 | 0 | 0 | 10 | 10 | 10 | 10 | 0 | 0 |
| | | Ep828 | 0 | 0 | 0 | 0 | 0 | 0 | 0 | 0 | 0 | 0 | 0 |
| | | GAN | 0 | 0 | 0 | 0 | 0 | 0 | 0 | 0 | 0 | 0 | 0 |
| | | BOX-F | 0 | 0 | 0 | 0 | 0 | 0 | 0 | 0 | 0 | 0 | 0 |
| | | DEN439 | 0 | 0 | 0 | 0 | 0 | 0 | 0 | 0 | 0 | 0 | 30 |
| | | EPN1138 | 0 | 0 | 0 | 0 | 0 | 0 | 0 | 0 | 0 | 0 | 10 |
| | Curing agent | 4-4′DDS | 0 | 0 | 0 | 0 | 0 | 0 | 0 | 0 | 0 | 45 | 0 |
| | | AAA | 31 | 31 | 25 | 0 | 0 | 31 | 31 | 31 | 31 | 0 | 32 |
| | | SAA | 0 | 0 | 0 | 31 | 0 | 0 | 0 | 0 | 0 | 0 | 0 |
| | | DABA | 0 | 0 | 0 | 0 | 33 | 0 | 0 | 0 | 0 | 0 | 0 |
| | | DICY | 0 | 0 | 0 | 0 | 0 | 0 | 0 | 0 | 0 | 0 | 0 |
| | Accelerator | U-24 | 0 | 0 | 0 | 0 | 0 | 0 | 0 | 0 | 0 | 0 | 0 |
| | | EPTS | 0 | 0 | 0 | 0 | 0 | 0 | 0 | 0 | 0 | 0 | 0 |
| | | DCMU | 0 | 0 | 0 | 0 | 0 | 0 | 0 | 0 | 0 | 0 | 3.5 |
| | Interfacial | CSR | 5 | 5 | 5 | 5 | 5 | 5 | 0 | 0 | 5 | 10 | 5 |
| | material | | | | | | | | | | | | |
| | Migrating | PES1 | 0 | 0 | 0 | 6 | 6 | 0 | 0 | 0 | 0 | 0 | 0 |
| | agent | PES2 | 12 | 14 | 0 | 0 | 0 | 12 | 12 | 12 | 12 | 12 | 14 |
| | | PVF | 0 | 0 | 0 | 0 | 0 | 0 | 0 | 0 | 0 | 0 | 0 |
| | | PEI | 0 | 0 | 7 | 0 | 0 | 0 | 0 | 0 | 0 | 0 | 0 |
| | Optional | PA | 0 | 30 | 0 | 0 | 0 | 0 | 0 | 0 | 0 | 0 | 0 |
| Fiber | Type-1 sizing | T800S-10 | 0 | 0 | 0 | 0 | 0 | 0 | 0 | 0 | 0 | 0 | 0 |
| (wt %) | Type-3 sizing | T800G-31 | 0 | 0 | 0 | 0 | 0 | 0 | 0 | 0 | 0 | 0 | 0 |
| | | T700G-31 | 100 | 100 | 100 | 100 | 100 | 0 | 100 | 0 | 0 | 0 | 100 |
| | | MX-30 | 0 | 0 | 0 | 0 | 0 | 100 | 0 | 100 | 0 | 0 | 0 |
| | Type-5 sizing | M40J-50 | 0 | 0 | 0 | 0 | 0 | 0 | 0 | 0 | 100 | 0 | 0 |
| | | MX-50 | 0 | 0 | 0 | 0 | 0 | 0 | 0 | 0 | 0 | 100 | 0 |
| | Type-6 sizing | T700S-60 | 0 | 0 | 0 | 0 | 0 | 0 | 0 | 0 | 0 | 0 | 0 |
| Prepreg | Fiber area weight, g/m² | | 190 | 190 | 190 | 190 | 190 | 190 | 190 | 190 | 190 | 190 | 150 |
| | Resin content, wt % | | 34 | 34 | 34 | 35 | 35 | 37 | 35 | 37 | 36 | 37 | 33 |
| | Fiber area weight, g/m² | | 190 | 190 | 190 | 190 | 190 | 190 | 190 | 190 | 190 | 190 | 150 |
| Cured resin | K_{IC} (Mpa · m^{0.5}) | | 0.7 | 0.8 | 0.8 | 0.8 | 0.8 | 0.7 | 0.6 | 0.6 | 0.8 | 1.0 | 0.9 |
| | Flexure modulus @ RTD (GPa) | | 4.7 | 4.5 | 4.1 | 4.1 | 4.2 | 4.7 | 5.0 | 5.0 | 4.7 | 2.8 | 4.2 |
| | Flexural deflection (mm) | | 5.5 | 5.8 | 6.0 | 4.7 | 4.7 | 5.5 | 3.0 | 3.0 | 5.0 | 6.5 | 5.5 |
| Reinforced interphase | | Yes: >50% | Yes | Yes | Yes | Yes | Yes | Yes | No | No | No | Yes | Yes |
| existence by particle | | No: <50% | | | | | | | | | | | |
| coverage on fiber | | Thickness (um) | 0.1-0.5 | 0.1-0.5 | 0.1-0.5 | 0.1-0.5 | 0.1-0.5 | 0.1-0.5 | | | | 0.1-0.5 | 0.1-0.5 |
| Composite | Tension* | Ultimate | 386 | 380 | 370 | 360 | 355 | 330 | 285 | 280 | 230 | 305 | 410 |
| | | strength (ksi) | | | | | | | | | | | |
| | | Translation** | 96 | 94 | 92 | 91 | 90 | 86 | 72 | 73 | 65 | 79 | 100 |
| | | (%) | | | | | | | | | | | |
| | Fracture | G_{Ic} (lb · in/in²) | 4.0 | 3.8 | 4.5 | 4.0 | 4.2 | 3.2 | 3.0 | 2.2 | 1.4 | 1.5 | 4.6 |
| | toughness | G_{IIC} (lb · in/in²) | | 10.0 | | | | | | | | | |
| | Adhesion | Interlaminar | 16.8 | 17.0 | 16.0 | 15.5 | 15.8 | 17.4 | 17.9 | 14.5 | 14.5 | 15.3 | 15.6 |
| | | shear strength (ksi) | | | | | | | | | | | |
| | Flexure | 0° (ksi) | | | | | | | | | | | 271 |
| | | 90° (ksi) | | | | | | | | | | | 16.0 |
| | Compression* | Ultimate | 235 | 230 | 220 | 219 | 222 | 225 | 215 | 210 | 212 | 175 | 232 |
| | | strength (ksi) | | | | | | | | | | | |

| | | | Example | | | C.E. | | | Example | | | | C.E. |
|---|---|---|---|---|---|---|---|---|---|---|---|---|---|
| | | | 8 | 9 | 10 | 5 | 6 | 7 | 11 | 12 | 13 | 14 | 8 |
| Resin | Thermosetting | ELM434 | 60 | 60 | 60 | 60 | 50 | 10 | 60 | 60 | 60 | 40 | 60 |
| | | EPON825 | 0 | 0 | 30 | 0 | 0 | 0 | 10 | 10 | 0 | 0 | 20 |
| | | EPc830 | 0 | 0 | 10 | 0 | 20 | 0 | 0 | 0 | 0 | 0 | 20 |
| | | EP1001 | 0 | 10 | 0 | 0 | 0 | 0 | 0 | 0 | 0 | 0 | 0 |
| | | Ep2005 | 0 | 0 | 0 | 0 | 30 | 30 | 10 | 10 | 0 | 0 | 0 |
| | | Ep828 | 0 | 30 | 0 | 0 | 0 | 60 | 0 | 0 | 0 | 0 | 0 |
| | | GAN | 0 | 0 | 0 | 0 | 0 | 0 | 20 | 20 | 0 | 0 | 0 |
| | | BOX-F | 0 | 0 | 0 | 0 | 0 | 0 | 0 | 0 | 40 | 60 | 0 |
| | | DEN439 | 30 | 0 | 0 | 30 | 0 | 0 | 0 | 0 | 0 | 0 | 0 |
| | | EPN1138 | 10 | 0 | 0 | 10 | 0 | 0 | 0 | 0 | 0 | 0 | 0 |
| | Curing agent | 4-4′DDS | 0 | 0 | 0 | 0 | 0 | 0 | 0 | 0 | 0 | 0 | 45 |
| | | AAA | 32 | 31 | 25 | 32 | 32 | 0 | 31 | 23 | 0 | 0 | 0 |
| | | SAA | 0 | 0 | 0 | 0 | 0 | 0 | 0 | 0 | 0 | 0 | 0 |
| | | DABA | 0 | 0 | 0 | 0 | 0 | 0 | 0 | 0 | 0 | 0 | 0 |
| | | DICY | 0 | 0 | 0 | 0 | 0 | 4 | 0 | 0 | 0 | 0 | 0 |
| | Accelerator | U-24 | 0 | 3 | 0 | 0 | 0 | 0 | 0 | 0 | 0 | 0 | 0 |
| | | EPTS | 0 | 0 | 4 | 0 | 0 | 0 | 0 | 0 | 2 | 2 | 0 |
| | | DCMU | 3.5 | 0 | 0 | 3.5 | 3.5 | 3.5 | 0 | 0 | 0 | 0 | 0 |
| | Interfacial | CSR | 5 | 5 | 5 | 0 | 0 | 0 | 5 | 5 | 5 | 5 | 5 |
| | material | | | | | | | | | | | | |
| | Migrating | PES1 | 0 | 0 | 0 | 0 | 0 | 0 | 0 | 0 | 0 | 0 | 6 |
| | agent | PES2 | 0 | 14 | 25 | 14 | 12 | 0 | 14 | 14 | 12 | 12 | 0 |
| | | PVF | 0 | 0 | 0 | 0 | 0 | 5 | 0 | 0 | 0 | 0 | 0 |
| | | PEI | 9 | 0 | 0 | 0 | 0 | 0 | 0 | 0 | 0 | 0 | 0 |
| | Optional | PA | 0 | 0 | 0 | 0 | 0 | 0 | 0 | 0 | 0 | 0 | 0 |
| Fiber | Type-1 sizing | T800S-10 | 0 | 0 | 0 | 0 | 0 | 0 | 0 | 0 | 0 | 0 | 100 |
| (wt %) | Type-3 sizing | T800G-31 | 0 | 0 | 0 | 0 | 0 | 0 | 100 | 100 | 100 | 100 | 0 |
| | | T700G-31 | 100 | 100 | 100 | 100 | 0 | 100 | 0 | 0 | 0 | 0 | 0 |
| | | MX-30 | 0 | 0 | 0 | 0 | 0 | 0 | 0 | 0 | 0 | 0 | 0 |
| | Type-5 sizing | M40J-50 | 0 | 0 | 0 | 0 | 0 | 0 | 0 | 0 | 0 | 0 | 0 |
| | | MX-50 | 0 | 0 | 0 | 0 | 0 | 0 | 0 | 0 | 0 | 0 | 0 |
| | Type-6 sizing | T700S-60 | 0 | 0 | 0 | 0 | 100 | 0 | 0 | 0 | 0 | 0 | 0 |
| Prepreg | Fiber area weight, g/m² | | 150 | 150 | 150 | 150 | 150 | 150 | 190 | 190 | 190 | 190 | 190 |
| | Resin content, wt % | | 34 | 34 | 33 | 34 | 33 | 33 | 34 | 34 | 34 | 34 | 34 |
| | Fiber area weight, g/m² | | 150 | 150 | 150 | 150 | 150 | 150 | 190 | 190 | 190 | 190 | 190 |
| Cured resin | K_{IC} (Mpa · m^{0.5}) | | 0.8 | 0.8 | 0.9 | 0.6 | 0.6 | 0.8 | 0.7 | 0.7 | 0.6 | 0.5 | 0.8 |
| | Flexure modulus @ RTD (GPa) | | 4.2 | 4.2 | 4.0 | 4.6 | 4.2 | 3.4 | 4.7 | 4.6 | 4.7 | 5.2 | 3.0 |
| | Flexural deflection (mm) | | 5.5 | 5.5 | 6.0 | 3.5 | 3.5 | 6.0 | 5.0 | 5.2 | 4.5 | 3.0 | 6.0 |
| Reinforced interphase | | Yes: >50% | Yes | Yes | Yes | No | No | No | Yes | Yes | Yes | Yes | Yes |
| existence by particle | | No: <50% | | | | | | | | | | | |
| coverage on fiber | | Thickness (um) | 0.1-0.5 | 0.1-0.5 | 0.1-0.5 | | | | 0.1-0.5 | 0.1-0.5 | 0.1-0.5 | 0.1-0.5 | 0.1-0.5 |
| Composite | Tension* | Ultimate | 400 | 405 | 411 | 395 | 380 | 363 | 461 | 444 | 454 | 445 | 485 |
| | | strength (ksi) | | | | | | | | | | | |
| | | Translation** | 99 | 100 | 100 | 98 | 92 | 88 | 95 | 92 | 94 | 92 | 100 |
| | | (%) | | | | | | | | | | | |
| | Fracture | G_{Ic} (lb · in/in²) | 4.2 | 4.0 | 4.1 | 2.9 | 2.5 | 1.5 | 2.9 | 3.1 | 3.2 | 3.0 | 5.5 |
| | toughness | G_{IIC} (lb · in/in²) | | | | | | | | | | | |
| | Adhesion | Interlaminar | 15.2 | 15.4 | 15.0 | 15.9 | 14.0 | 13.5 | 17.3 | 17.9 | 15.2 | 14.8 | 14.7 |
| | | shear strength (ksi) | | | | | | | | | | | |
| | Flexure | 0° (ksi) | | | | 266 | | 253 | | | | | |
| | | 90° (ksi) | | | | 14.6 | | 12.5 | | | | | |
| | Compression* | Ultimate | 230 | 240 | 228 | 216 | 205 | 201 | 240 | 230 | 235 | 245 | 190 |
| | | strength (ksi) | | | | | | | | | | | |

*Normalized to Vf = 60%
**Estimated based on resin content and fiber area weight using resin density of 1.22 g/cm³

TABLE 2

| | | | Ply Lay-up | Test |
|---|---|---|---|---|
| | | Panel Size | Configura- | Condi- |
| Test Panel | Test method | (mm × mm) | tion | tion |
| 0deg-Tensile | ASTM D 3039 | 300 × 300 | (0)₆ | RTD |
| Compression | ASTM D | 300 × 300 | (0)₆ | RTD |
| strength | 695/ASTM D | | | |
| | 3410 | | | |
| ILSS | ASTM D-2344 | 300 × 300 | (0)₁₂ | RTD |
| DCB (for G_{IC}) | ASTM D 5528 | 350 × 300 | (0)₂₀ | RTD |
| 0°/90° Flexure | ASTM D 790 | 300 × 300 | (0)₁₂ | RTD |
| ENF (for G_{IIC}) | JIS K 7086* | 350 × 300 | (0)₂₀ | RTD |

*Japanese Industrial Standard Test Procedure

### Translation Factor.

Percent translation is a measure of how effectively fiber's strength is utilized in a fiber reinforced polymer composite. It was calculated from the equation below, where a measured tensile strength (TS) is normalized by a measured strand strength of fibers and fiber volume fracture (V_{f}) in the fiber reinforced polymer composite. Note that V_{f} can be determined from an acid digestion method.

$$\% translation = \frac{T S}{Strand strength \times {V}_{f}} \times 100$$

1. A fiber reinforced polymer composition comprising a reinforcing fiber and an adhesive composition, wherein the adhesive composition comprises at least a thermosetting resin, a curing agent and an interfacial material, the adhesive composition when cured has a resin modulus of at least about 4.0 GPa and forms good bonds to the reinforcing fiber, the reinforcing fiber is suitable for concentrating the interfacial material in an interfacial region between the reinforcing fiber and the adhesive composition, and the interfacial region comprises at least the interfacial material.

2. The fiber reinforced polymer composition of claim 1, wherein the cured adhesive composition has a resin modulus of at least about 4.0 GPa and a resin flexural deflection of at least 3 mm, the interfacial material is concentrated in-situ in the interfacial region during curing of the thermosetting resin such that the interfacial material has a gradient in concentration in the interfacial region.

3. The fiber reinforced polymer composition of claim 2, additionally comprising a migrating agent.

4. The fiber reinforced polymer composition of claim 3, wherein the curing agent comprises at least an amide group and an aromatic group, wherein the amide group is selected from an organic amide group, a sulfonamide group or a phosphoramide group.

5. The fiber reinforced polymer composition of claim 4, wherein the curing agent additionally comprises a curable functional group, wherein the curable functional group is selected from nitrogen-containing groups, a hydroxyl group, a carboxylic acid group, and an anhydride group.

6. (canceled)

7. (canceled)

8. (canceled)

9. (canceled)

10. The fiber reinforced polymer composition of claim 3, additionally comprising an accelerator, a toughening agent, a filler or a combination thereof.

11. The fiber reinforced polymer composition of claim 3, additionally comprising thermoplastic particles having an average particle size of no more than about 100 μm, wherein after the adhesive composition is cured, the thermoplastic particles are localized outside a fiber bed comprising a plurality of the reinforcing fibers.

12. The fiber reinforced polymer composition of claim 3, wherein the interfacial material comprises at least one material selected from the group consisting of polymers, core-shell particles, inorganic materials, metals, oxides, carbonaceous materials, organic-inorganic hybrid materials, polymer grafted inorganic materials, organofunctionalized inorganic materials, polymer grafted carbonaceous materials, organofunctionalized carbonaceous materials and combinations thereof.

13. (canceled)

14. (canceled)

15. The fiber reinforced polymer composition of claim 3, wherein the interfacial material is present in an amount which is no more than about 30 weight parts per 100 weight parts of the thermosetting resin.

16. The fiber reinforced polymer composition of claim 3, wherein the migrating agent comprises a polymer, a thermoplastic resin, a thermosetting resin, or a combination thereof.

17. The fiber reinforced polymer composition of claim 16, wherein the thermoplastic resin comprises a polyvinyl formal, a polyamide, a polycarbonate, a polyacetal, a polyvinylacetal, a polyphenyleneoxide, a polyphenylenesulfide, a polyarylate, a polyester, a polyamideimide, a polyimide, a polyetherimide, a polysulfone, a polyethersulfone, a polyetherketone, a polyetheretherketone, a polyaramid, a polyethernitrile, a polybenzimidazole, a derivative thereof, or a combination thereof.

18. (canceled)

19. The fiber reinforced polymer composition of claim 3, wherein the migrating agent is present in an amount which is no more than about 35 weight parts per 100 weight parts of the thermosetting resin.

20. The fiber reinforced polymer composition of claim 3, wherein the migrating agent and the interfacial material are present in a ratio of migrating agent to interfacial material of about 0.1 to about 30, and wherein the interfacial material comprises a core-shell particle and the migrating agent comprises a polyethersulfone, polyetherimide, polyvinyl formal, or combination thereof.

21. A prepreg comprising the fiber reinforced polymer composition of claim 1.

22. (canceled)

23. (canceled)

24. A method of manufacturing a composite article comprising curing the fiber reinforced polymer composition of claim 1.

25. (canceled)

26. (canceled)

27. A fiber reinforced polymer composition comprising a carbon fiber and an adhesive composition, wherein the adhesive composition is comprised of an epoxy resin, an interfacial material comprising a core-shell particle, an amidoamine curing agent and a migrating agent selected from the group consisting of polyethersulfones, polyetherimides, and mixtures thereof, and wherein the interfacial material has a gradient in concentration in an interfacial region between the cured adhesive composition and the reinforcing fiber.

28. The fiber reinforced polymer composition of claim 27 wherein the amidoamine curing agent comprises at least an aromatic group.

29. (canceled)

30. The fiber reinforced polymer composition of claim 27, additionally comprising an accelerator, a toughening agent, a filler, an interlayer toughener or a combination thereof.

31. A fiber reinforced polymer composition comprising a reinforcing fiber and an adhesive composition, wherein the adhesive composition comprises at least a thermosetting resin, a curing agent and an interfacial material, wherein the interfacial material has a gradient in concentration in an interfacial region between the cured thermosetting resin and the reinforcing fiber, and the cured fiber reinforced polymer simultaneously achieves a tensile strength of at least 80% translation, a compression strength of at least 1380 MPa (200 ksi), and mode I fracture toughness of at least 350 J/m² (2 lb·in/in²).

32. The fiber reinforced polymer composition of claim 31, wherein the fiber reinforced polymer composition has an interlaminar shear strength (ILSS) of at least 90 MPa (13 ksi), 0° flexure of at least 1520 MPa (220 ksi), and 90° flexure of at least 83 MPa (12 ksi).
